(19) United States
(12) Patent Application Publication
(10) Pub. No.: US 2009/0119315 A1
(43) Pub. Date: May 7, 2009

(54) SYSTEM AND METHOD FOR PAIRING IDENTIFICATION DATA

(76) Inventor: RAYMOND P. KASBARIAN, Englewood Cliffs, NJ (US)

Correspondence Address: MALDJIAN & FALLON LLC, 365 BROAD ST. , 3RD FLOOR, RED BANK, NJ, 07701, US

(21) Appl. No.: 12/051,345

(22) Filed: Mar. 19, 2008

Related U.S. Application Data
(60) Provisional application No. 60/985,197, filed on Nov. 2, 2007.

(51) Int. Cl. G06F 17/30

(52) U.S. Cl. 707/100; 707/E17.005

(57) ABSTRACT

Embodiments of the present invention relate to a system and method for linking at least two unique identifying data points together for the purpose of simplifying a search or data entry process. In one embodiment of the present invention, a method of pairing identification data comprising providing a database for storing a first data set having individual source data and a second data set having individual destination data correlating to individual source data in the first data set, accessible via a global computer network, providing a data entry portal for entering input data, accessible from a user's computer via the global computer network, comparing input data to specific individual source data in the first data set, and supplying the user's computer with specific individual destination data, correlating to the specific individual source data, wherein the specific individual destination data comprises a specific uniform resource locator.

### CROSS-REFERENCE TO RELATED APPLICATION

This application claims the benefit of U.S. Provisional Patent Application No. 60/985,197, filed Nov. 2, 2007, entitled “System and Method for Pairing Identification Data,” the disclosure of which is incorporated by reference herein in its entirety.

### BACKGROUND OF THE INVENTION

1. Field of the Invention

Embodiments of the present invention generally relate to a system and method for pairing identification data. More specifically, embodiments of the present invention relate to a system and method for connecting at least two unique identifying data points together for the purpose of simplifying a search or data entry process.

2. Description of the Related Art

Typically, in order for a user to obtain and view material on a web page, a Uniform Resource Locator (URL) must be input into a Web browser, such as Internet Explorer, Mozilla Firefox and Netscape. Many times, URLs are complex and arduous to employ, as they are difficult to remember and recite, are often language specific, and can result in users becoming frustrated to the point of abandoning the input process. In such cases users is left with no resolution to their inquiry. Some URLs contain plays on words or words with unconventional spellings, abbreviations for long organization names, long and complex addresses (i.e. hyphens, underscores or other non-intuitive or unconventional identifiers). URLs such as these are difficult to remember, recite and therefore, replicate, without the aid of a pen and paper, and often forces users to abandon locating a URL with no resolution or satisfaction.

This problem is further compounded when considering the vast exponential growth of registered URLs, and the existence of cyber-squatters or persons who register URLs in the hopes of one day selling or exploiting them. Thus, people who wish to create a website, must either buy an existing URL from a person or company who previously has registered the desired domain name, or create a new URL having at least one or more of the problems above.

Additionally, websites for entities with difficult names or derived from non-mother-tongue names can be particularly difficult to remember, and recall efforts may oftentimes prove futile, as a spoken name of a venue may not easily translate to writing, e.g., for an English speaker, La Grenouille Restaurant. Efforts to search for the website of this sort of venue using a search engine, such as Google or Yahoo!, may take a great amount of time, produce an unreasonable volume of results, and the proper website may or may not be found. Searches for these types of venues may also yield a false positive result. For example, the website found may not be and this may be mistaken for the website corresponding to the targeted venue.

Often difficulties may arise when trying to locate a particular company's web page via a public search engine. For example, if the name of a particular restaurant is entered into a search engine, the first few pages of results may be related to the desired restaurant; however, these pages belong to restaurant critics, web bloggers, advertising forums, or the like.

Attempts have been made to overcome some of the apparent problems in the art. However, many of the solutions are not directed toward general public use and comprise intricate and complex steps.

U.S. Pat. No. 6,539,077 (the '077 patent) generally teaches a personal address book for looking up an Internet address for a Voice over Internet Protocol (VoIP) telephone system by mating the telephone number with an Internet address. The system disclosed in the '077 patent utilizes a telephone number and an Internet connection to form a free telephone communication link between two parties. Additionally, the system may be used to retrieve a caller's Internet web page by providing a link between the telephone number of the caller and the URL corresponding to the web page of that caller. However, the system disclosed by the '077 patent requires the use of a VoIP system to acquire any such information, and the system provides an accessible link to a corresponding web page, very similar to web search engines.

Similarly PCT International Patent Application Publication No. PCT/US00/56049 addresses some of the problems discussed herein. The reference discloses a telephone answering apparatus which, upon receiving a telephone call from a client and looking in a local private personal address book, will automatically provide the URL of the website of the client. Embodiments of the invention disclosed by PCT/US00/56049 comprise a system wherein the telephone answering apparatus includes a storage device that stores information in the form of a database or similar application which (links) telephone numbers with URLs. The disclosure of this reference requires the use of a host terminal, as opposed to a direct internet connection, or alternatively, requires the user to click an accessible link, which carries the same pitfalls as discussed above with respect to the '077 patent.

Another attempted solution to the problems already discussed is provided in UK Patent Application No. 2 358 718, generally directed towards a method and apparatus for retrieving Internet web pages by referencing a corresponding telephone number in a personally created address book. More specifically, embodiments of the invention disclosed by this patent application utilize a host computer and a terminal computer and a communication link therebetween, and a database which stores telephone numbers and their corresponding Internet addresses, wherein a user inputs a telephone number and a corresponding Internet address is output by the system, similar to the system taught by PCT/US00/56049. The disclosure of this reference requires the use of a host terminal, as opposed to a direct internet connection, or alternatively, requires the user to click an accessible link, which carries the same pitfalls as discussed above with respect to the above references.

Currently available search engines, such as Google, Yahoo!, AltaVista, Ask Jeeves, Dogpile, MSN, and others allow for a user to search for a uniform resource locator (URL) referencing a desired website using one or more keywords. When these keywords are input into the search engine, one or more web pages are returned which contain one or more of the entered keywords. However, the desired web page may not appear in the list of search results. Additionally, depending on the keywords entered and the format of the entry (including Boolean operators, wildcards, etc.), the desired website may not be the first entry on the list of search results.

Thus, there is a need for a system and method of pairing identification data for simplifying search and data entry processes, such that a user enters a telephone number or other string and is instantly connected to a desired web page, i.e., the user is not required to go through multiple steps, thereby saving time and providing accurate results, previously verified.

### SUMMARY OF THE INVENTION

Embodiments of the present invention relate to a system and method for linking at least two unique identifying data points together for the purpose of simplifying a searching or data entry process. In one embodiment of the present invention, a method of pairing identification data comprising providing a database for storing a first data set having individual source data and a second data set having individual destination data correlating to individual source data in the first data set, accessible via a global computer network, providing a data entry portal for entering input data, accessible from a user's computer via the global computer network, comparing input data to specific individual source data in the first data set, and supplying the user's computer with specific individual destination data, correlating to the specific individual source data, wherein the specific individual destination data comprises a specific uniform resource locator.

In another embodiment of the present invention, a system of pairing identification data comprises a database, stored on a central server, having a first data set having individual source data and a second data set having a plurality of uniform resource locators, each uniform resource locator correlating to at least one individual source data in the first data set, accessible via a web browser of a computer on the global computer network, a single-action submission component that in response to performance of only a single action, submits a request to the database, the request comprising an input data component, consisting of a unique identifier, so the database can compare and match the unique identifier to the individual source data in the first data set, and a return data component, comprising a uniform resource locator correlating to the individual source data matched to the unique identifier, and instructions for the Web browser of a computer on the global computer network, wherein the instructions direct the web browser to the uniform resource locator.

In yet another embodiment of the present invention, a method of reaching a web page identified by a uniform resource locator via a web browser, on a user's computer connected to a global computer network, comprises providing a database for storing a set of unique identifiers in a first data set and a set of uniform resource locators in a second data set, correlating to at least one of the unique identifiers in the first data set, accessible via the global computer network, providing a data entry portal for entering input data, accessible from a user's computer via the global computer network, comparing the input data to the set of unique identifiers in the first data set to obtain the correlating uniform resource locator, and connecting a web browser on the user's computer with the uniform resource locator in the second data set, correlating to the unique identifier in the first data set.

In an additional embodiment of the present invention, a computer readable medium comprises a computer program having executable code, the computer program for enabling data pairing, the computer program comprising instructions for: storing a first data set having individual source data and a second data set having individual destination data correlating to individual source data in the first data set, in a database, accessible via a global computer network from a user's computer, accepting input data entered from the user's computer, comparing the input data to individual source data, and sending individual destination data correlating to the individual source data to the user's computer, wherein the individual destination data comprises a uniform resource locator.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of a general computer system in accordance with one embodiment of the present;

FIG. 2 depicts a diagram of data flow within a system in accordance with one embodiment of the present invention;

FIG. 3 depicts a general system diagram in accordance with one embodiment of the present invention;

FIG. 4 depicts a flowchart of a basic method of pairing identification data in accordance with one embodiment of the present invention; and

FIG. 5 depicts a flowchart of a method of pairing identification data in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a system and method for pairing identification data. More specifically, embodiments of the present invention relate to a system and method for connecting at least two unique identifying data points together for the purpose of simplifying a search or data entry process.

FIG. 1 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. A display for use in the present invention may include a computer monitor, television screen, projection screen, or any other display feasible in the context of the present invention. The storage system 111 may comprise any type of block-based storage device or devices, such as a disk drive system or other computer-readable medium, such as compact disk, floppy disk, universal serial bus (USB) flash drive, or any other storage device conceivable in embodiments of the present invention.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read-only memory, magneto-resistive read/write memory, optical read/write memory, cache memory, magnetic read/write memory, and the like.

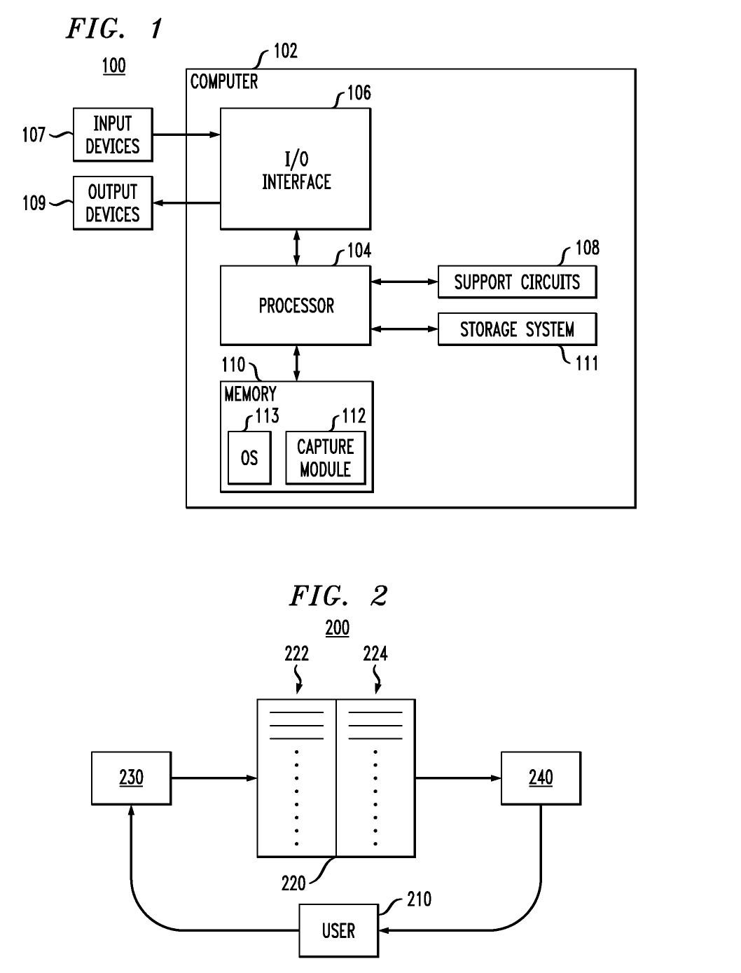

FIG. 2 depicts a diagram of data flow within a system in accordance with one embodiment of the present invention. In one embodiment of the present invention, a system 200 is provided for enabling the pairing of identification data. Generally, the system comprises a user 210 (e.g., a computer) an input device 230, a database 220, and an output device 240. Generally, the user 210 provides input data to the input device 230. The input data generally comprises any input data suitable for embodiments of the present invention, hereinafter collectively referred to as a “unique identifier.”

In one embodiment, the input data comprises an alphanumeric string, e.g., a telephone number, a zip code, an airport code, GPS coordinates, a jump code (i.e., an abbreviated code comprising letters and/or numbers, unique to a particular venue, business, government, location or person), or the like. In another embodiment, the input data comprises a voice/audio data signal, input to the system through a microphone or other audio recording device. Such voice/audio signals may include voice commands, artificially-produced sound effects, and any other voice/audio signal feasible in the context of the present invention. In yet another embodiment, the input comprises visual data signals, such as particular hand signals, body movement, or the like, optionally in combination with an audio data signal. In yet a further embodiment of the present invention, the input data comprises at least one of an optical or radio signal, for example, at least one of a barcode or Radio Frequency Identification Data (RFID) signal, respectively, and the like.

The input device 230 receives the input data from the user 210 and transits a data query to the database 220. The database may be any data storage database suitable for embodiments of the present invention. For example, the database 220 comprises at least one or more database management systems, such as any of an Oracle, DB2, Microsoft Access, Microsoft SQL Server, Postgres, MySQL, 4th Dimension, FileMaker, Alpha Five Database Management System, and the like.

Contained within the database 220 are at least two data sets 222, 224. The first data set 222 comprises a plurality of predetermined unique identifiers, such as any of the types of data (or binary representations thereof) as disclosed above. The second data set 224 comprises plurality of unique destination data, whereby each unique destination data correlates to at least one of the unique identifiers in the first data set 222. The unique destination data may comprise any identifying data, including, but not limited to a uniform resource locator (URL), internet protocol address (IP address), and the like.

When a user 210 provides input data to the input device 230, a data query is run in the database 220. If the data query matches the input data to a unique identifier in the first data set 222, the corresponding unique destination data from the second data set 224 is transferred to an output device 240. In many embodiments, the output device 240 returns the unique destination data to the user 210.

FIG. 3 depicts a general system diagram in accordance with one embodiment of the present invention. In accordance with one embodiment of the present invention, a system 300 comprises at least a user 310, a database 320, a computer network 330 (e.g., the Internet), and a plurality of web sites 340₁, 340₂, . . . 340ₙ, generally hosted on at least one remote server, at particular URLs, addressable by unique IP addresses.

The user 310 may comprise any computer device, as discussed above with respect to FIG. 1. Generally, however, the user 310 may comprise a personal computer (PC), Mac, mobile computer (e.g., laptop with mobile connectivity to a computer network), a wireless handheld computer (e.g., Blackberry, Treo, etc.), a mobile telephone, and the like. In such embodiments, the user 310 is in communication with a computer network 330 including, but not limited to, a global computer network, an internal network, local-area networks, wireless networks, and the like, via any suitable connection means or communication protocol generally available to those of ordinary skill in the art. In accordance with many embodiments of the present invention, the computer network 330 often comprises any public or “unrestricted” computer network, for example, the Internet.

The database 320 may comprise any data storage database suitable for embodiments of the present invention. For example, the database 320 comprises at least one or more database management systems, such as any of an Oracle, DB2, Microsoft Access, Microsoft SQL Server, Postgres, MySQL, 4th Dimension, FileMaker, Alpha Five Database Management System, and the like. The database 320 may be provided on a computer device or server, remotely located from the user 310. Generally, the database 320 is in communication with the computer network 330 via any suitable connection means or communication protocol, generally available to those of ordinary skill in the art.

The plurality of web sites 340₁₋ₙ are discussed herein as a single web site, however, it is understood by embodiments of the present invention that any number of web sites may exist on a computer network 330, and the content of any one web site bears no weight on the content or functionality of another web site on the same computer network 330. Each web site 340 provided on the computer network 330 comprises at least a URL identification (i.e., web address) and a IP address, unique to the particular web site 340, capable of having content displayed in a web browser (e.g., Internet Explorer, Mozilla, Firefox, and the like).

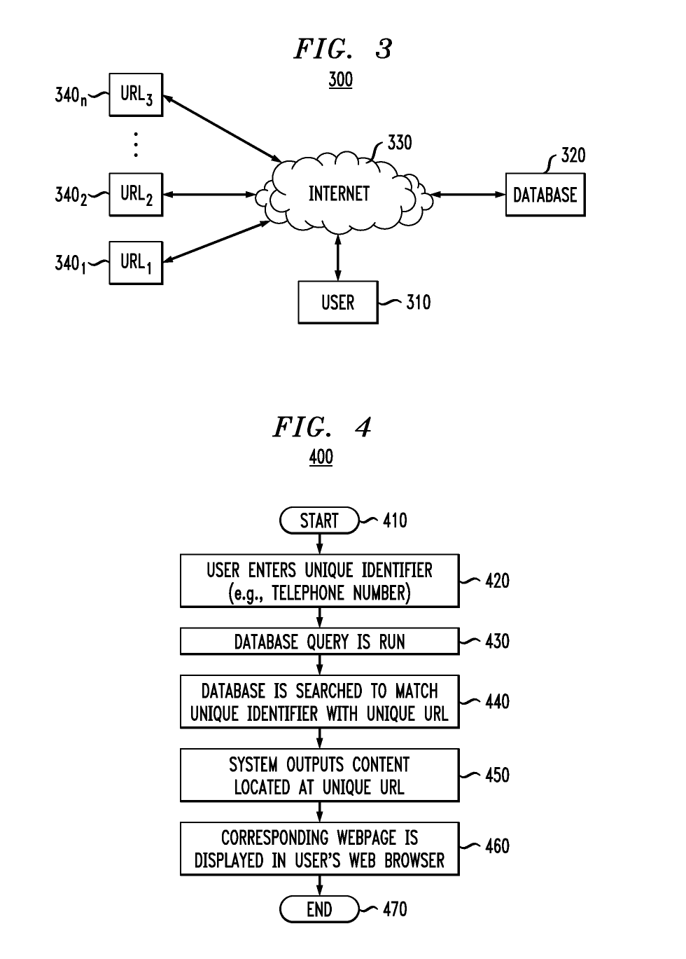

FIG. 4 depicts a flowchart of a basic method of pairing identification data in accordance with one embodiment of the present invention. The method 400 begins at step 410, whereby a user having a personal computer capable of accessing the Internet via a web browser enters a predetermined URL (e.g., http://www.gotelo.com) into the web browser to arrive at a host web site. At step 420, the user enters a unique identifier (e.g., a particular unique alphanumeric code or a publicly accessible ten-digit United States telephone number) into a query box located on the host web site. At step 430, a “submit” button is pressed (or clicked) by the user, and a database query is run and the database is searched to match the entered unique identifier with at least one of the plurality of unique identifiers stored in a first data set of the database.

At step 440, the system returns unique destination data from a second data set for the matched unique identifier found in the first data set of the database. Often, the unique destination data corresponds to at least one of a URL or IP address. At step 450, the unique destination data is transmitted to the user's web browser, and at step 460, the corresponding web page for the unique destination data is displayed in the user's web browser. As understood by embodiments of the present invention, steps 430 to steps 460 occur with a single operation by the user (i.e., “one-click” process). The method 400 ends at step 470.

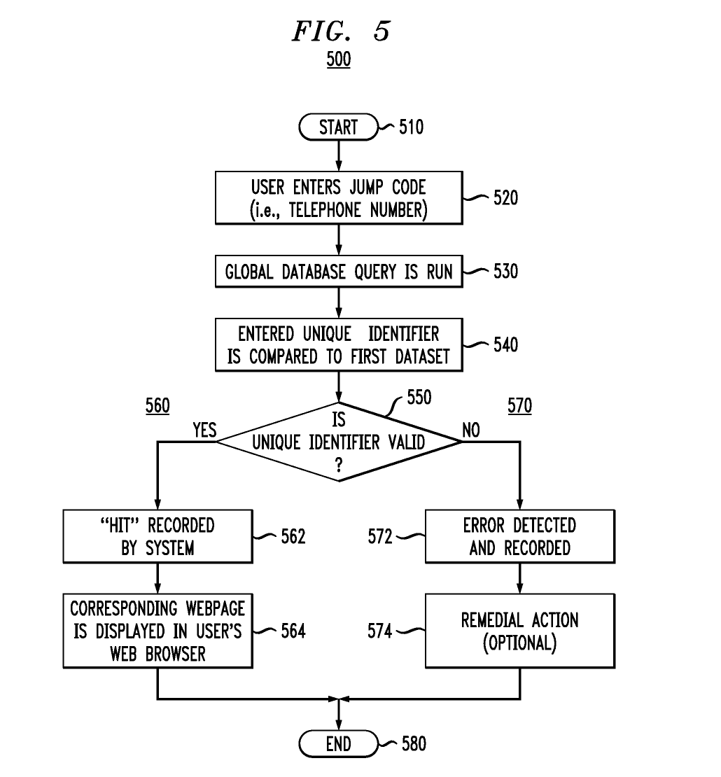

FIG. 5 depicts a flowchart of another method of pairing identification data in accordance with one embodiment of the present invention. The method 500 begins at step 510, whereby a user having a computer capable of accessing the Internet via a web browser enters a predetermined URL into the web browser to arrive at a host web site. At step 520, the user enters a unique identifier into a query box located on the host web site. At step 530, a database query is run. At step 540, the database is searched to match the entered unique identifier with at least one of the unique identifiers stored in a first data set of the database.

At step 550, a validity analysis on the entered query is conducted. In one embodiment, if the entered unique identifier is matched to at least one of the unique identifiers stored in the first data set of the database 560, a “hit” is recorded by the server hosting the database (i.e., the database acknowledges that a match has been found) 562, and the corresponding webpage is displayed in the user's web browser 564. If the entered unique identifier is not matched to at least one of the unique identifiers stored in the first data set of the database 570, an “error” is recorded by the server hosting the database, which is also provided to the user 572.

Subsequently, an optional remedial action is taken by the server hosting the database 574. For example, in one embodiment, wherein the user entered a telephone number as a unique identifier, an automated telephone call is placed to the telephone number and a pre-recorded message informs the party located at the telephone number that such a query was run.

Alternatively, a remedial action may comprise displaying a web-accessible search engine in the user's web browser and conducting a web search using the user-entered unique identifier. As would be done with a standard search engine, the user may select from a list of web addresses, each optionally displaying a brief description of the web page. When the user selects a web page believed to be the correct URL for the entered unique identifier, the content of the selected web page is displayed. The user is then given an opportunity to determine whether the selected displayed web page is the desired destination. If the displayed web page is the correct destination, the user may indicate so by selecting or clicking a button on the web browser, in which instance, the database is updated to reflect the appropriate corresponding URL to the initially input unique identifier. If the displayed web page is not correct, the user may also indicate so, in which instance, the user is returned to the results of the search engine. The method 500 generally ends at step 580.

Alternative embodiments of the present invention generally incorporate the structures and methods described in the embodiments above, with minor additions and/or modifications. The following embodiments may be considered independently or in combination with any other embodiment contained herein.

Many embodiments of the present invention use a system of unique identifiers to link to more complex data in order to simplify a search or data entry process. One embodiment of the present invention provides for the use of “jump codes” associated with a URL in an Internet-based application. In such an embodiment, a user may input an alphanumeric code which connects directly to a target web page in a customizable database. In other embodiments of the present invention, the jump code used to link to a particular URL is an alphanumeric string, a value expressed in binary format, a memory address, or any other short-form code conceivable in the context of embodiments of the present invention.

In accordance with various embodiments of the present invention, a user may access a particular website which provides a data portal to interact directly with a database. As the user enters a valid unique identifier in a query input, the database matches the unique identifier to the associated URL and the target website is displayed in the user's web browser application.

In another embodiment of the present invention, a system is mobile-based, such that the user utilizes a mobile telephone, palm pilot, or similar mobile device, wirelessly connectable to the Internet. The user enters a unique identifier (e.g., telephone number) into the system on the mobile device and sends a query to the database. The database returns an associated URL, and an Internet browser located on the mobile device is connected to the web page represented by the returned URL.

In at least one embodiment of the present invention, the methods and system of the present invention may be incorporated into downloadable and executable software, which installs a query bar on a user's computer desktop screen, such that independent opening of a Web browser is not necessary. For example, once downloaded and executed, a user whose computer is always connected to a global computer network need only enter a unique identifier on a query bar on the desktop screen, run the query, and a Web browser opens, displaying the web page represented by the target URL. In other embodiments of the present invention, the query bar may be exemplified in the form of a text box, input message box, sound capture software interface, visual signal capture software interface, or any other query system conceivable in the context of embodiments of the present invention.

In another embodiment, persons and businesses, whose URLs and unique identifiers are stored in the system, are presented with a fee-based system. In such a system, the persons and businesses may pay a predetermined fee to have their URLs and unique identifiers stored in the system without any advertisements being displayed. The fee-based system may be based on a fixed one-time fee, a periodic fee (such as a weekly, monthly, or annual fee), or any other fee schedule feasible in the context of the present invention. Alternatively, for free, or for a lower fee, persons and businesses may store their URLs and unique identifiers in the system; however, advertisements may be displayed via banners when users view the target URL's content.

Optionally, in accordance with various embodiments of the present invention, a method of advertising may be utilized in the systems described above. In one embodiment, as a user enters a unique identifier into a database query, the user is presented with a variety of targeted advertisements, for example, based on the user's previous history (i.e., information stored of the user's computer), or selected by random. Such advertisements may be presented as web pages, audio messages, video messages, or any combination thereof which is feasible in embodiments of the present invention.

In other embodiments, a method of tracking the frequency by which users, or a particular user, enters a specific unique identifier. In such an embodiment, a particular unique identifier may be presented in a paper or virtual advertisement in connection with a particular company. By entering a unique identifier (e.g., telephone number or other company-related code), an accurate accounting and measurement of effectiveness and use of any particular advertisement may be tracked by embodiments of the present invention. Embodiments of the present invention accept the unique identifier as entered into the system by the system user and record a “hit” in a separate storage system (recorded as an increment to a count value or in any other manner feasible in the context of the present invention), such as a database or spreadsheet. In accordance with embodiments of the present invention, the unique identifier is then sent to the database containing unique identifiers and URLs as a query, and the database returns a unique URL corresponding to the unique identifier.

Embodiments of the present invention further comprise systems, methods and means to add to, update and modify the data sets within the database discussed herein. In one embodiment, any member of the public may visit a predetermined web site whereby information may be uploaded, consisting of at least a unique identifier and a destination address (i.e., URL). In alternative embodiments, a plurality of uniquely identifying information may be associated with one particular URL. For example, it may be desirable to associate a zip code, telephone number, street address, and GPS coordinates with a single URL (e.g., a municipality's official home page). In such an embodiment, a user may enter any of the zip code, telephone number, street address or GPS coordinates into the input data query, and the same web page would display for each data input.

In yet another embodiment, the data sets within the database may be updated by a single database administrator. In such an embodiment, all requests for updates, additions or modifications must be made via email, instant message, data submission or the like, to an individual responsible for screening, verifying and adding such information to the database. In some embodiments, the individual may be replaced by automated verification systems. Such general data verification systems are readily available in the industry.

The following are exemplary, non-limiting commercial uses of embodiments of the present invention, intended to provide an insightful view of the breadth of applicability of such embodiments.

### EXAMPLE 1

A system in accordance with embodiments of the present invention is utilized in the restaurant and food service industry to provide information about a particular restaurant or dining location at the request of the system user. A user of the system may enter a unique identifier (for example, a restaurant's telephone number) into a query box. As the query is run, a database, which contains a unique URL for each unique identifier in the system, provides the content located at the particular unique URL. The web page corresponding to that restaurant is displayed in the system user's web browser, with no intervening steps. Often the website provides a menu, photographs, beverage lists, biographies, and the like. Optionally, the user may choose to be redirected to a page wherein an order can be placed, prepaid, and sent to the restaurant via e-mail, instant message, facsimile, or any other method of communication feasible in the context of embodiments of the present invention. The order can then be filled by the targeted dining location, providing an increase in sales for the dining establishment, and an increased convenience for the consumer/system user.

### EXAMPLE 2

The system of the present invention is utilized for local, state and national government websites. A user of the system may enter a unique identifier (for example, a town's ZIP code) into a query box. As the query is run, a database, which contains a unique URL for each unique identifier in the system, provides the content located at the particular unique URL. Generally, for government websites, the URL provided connects the system user's web browser to the local city hall's or state capitol's website. These websites generally provide any information a resident of the town, city or state may need to know regarding local events. However, the URL provided by the database search may connect the system user's web browser instead to a tourism web page or an online Web mapping service page (e.g. Mapquest, Google Maps, etc.) indicating the location of the municipality corresponding to the submitted ZIP code, or any other information source conceivable in the context of the present invention.

### EXAMPLE 3

A system in accordance with embodiments of the present invention is utilized for individual's personal social networking web page (e.g., MySpace, FaceBook, Garfum, etc.). An individual may register a home phone number, mobile phone number, code word, or pseudonym with the system as a unique identifier. The unique identifier submitted is stored in a database and paired with a unique URL corresponding to the individual's personal social networking web page. A user may utilize this system in a manner such that when the user enters the individual's unique identifier, the individual's personal social networking web page is presented, thus eliminating the necessity to recall and recite a long URL.

### EXAMPLE 4

The system of the present invention is also used for marketing and advertising and tracking thereof. In an embodiment of the present invention wherein a jump code used is a telephone number, a system user enters a jump code into a query box, and the global database is queried. The system then performs an error check to determine if the jump code entered is valid in the context of the system of the present invention. If the jump code entered is determined to be a valid jump code, the hit will be recorded, and the corresponding URL will be provided to the user, which can be used by either the system or the user to retrieve the corresponding web page. However, if the jump code entered has no corresponding URL linked to it, an error will occur and the user will be informed of such via a message box, audio signal, or any other method of communication feasible in the context of the present invention. In the latter case, the system will send a message, in the form of an audio message or otherwise, to the telephone number corresponding to the jump code which was entered into the system as a marketing or advertising announcement. The announcement states that the telephone number of the venue or establishment was the target of a request for information and the owner of the targeted establishment may wish to explore further options relating to registering to participate in the system.

### EXAMPLE 5

A system in accordance with embodiments of the present invention also has applications in the field of navigational technology. A person desiring to acquire directions to a particular venue or establishment enters a unique identifier (for example, a telephone number) into a query box. As the query is run, a database, which contains a unique URL for each unique identifier in the system, provides the content located at the particular unique URL. The web page identified by the returned URL is then displayed by the system user's Web browser application. Generally, on most websites for venues and establishments where people are able to visit, an address appears at some location on the website corresponding to that establishment. Once the address is obtained, the system user can submit the address to a cartography or navigational technology service, such as MapQuest, Google Maps, and the like, in order to obtain the location of the establishment, and optionally, driving directions to the targeted venue.

While the foregoing is directed to embodiments of the present invention, other and further embodiments of the invention may be devised without departing from the basic scope thereof.

What is claimed is:

1. A method of pairing identification data comprising:
providing a database for storing a first data set having individual source data and a second data set having individual destination data correlating to individual source data in the first data set, accessible via a global computer network;
providing a data entry portal for entering input data, accessible from a user's computer via the global computer network;
comparing input data to specific individual source data in the first data set; and
supplying the user's computer with specific individual destination data, correlating to the specific individual source data;
wherein the specific individual destination data comprises a specific uniform resource locator.

2. The method of claim 1, wherein the specific uniform resource locator is the address of an unsecured, publicly accessible web site.

3. The method of claim 1, wherein the steps of equating input data to individual source data in the first data set and supplying the user's computer with the individual destination data in the second data set, correlating to the individual source data in the first data set, are initiated with a single-action submission of entered input data by the user.

4. The method of claim 1, further comprising:
connecting a web browser on the user's computer to the specific uniform resource locator correlating to the specific individual source data.

5. The method of claim 4, further comprising:
providing a means for adding to the first and second data sets on the database; and
uploading individual source data and correlating individual destination data.

6. The method of claim 5, further comprising:
validating uploaded individual source data and correlating individual destination data.

7. The method of claim 1, wherein the input data comprises a unique identifier.

8. The method of claim 7, wherein the unique identifier comprises a telephone number.

9. The method of claim 7, wherein the unique identifier comprises one of at least a zip code, an airport code, GPS coordinates, or a jump code.

10. A system of pairing identification data comprising:
a database, stored on a central server, having a first data set having individual source data and a second data set having a plurality of uniform resource locators, each uniform resource locator correlating to at least one individual source data in the first data set, accessible via a web browser of a computer on the global computer network;
a single-action submission component that in response to performance of only a single action, submits a request to the database, the request comprising an input data component, consisting of a unique identifier, so the database can compare and match the unique identifier to the individual source data in the first data set; and
a return data component, comprising a uniform resource locator associated with the individual source data matched to the unique identifier, and instructions for the Web browser of a computer on the global computer network;
wherein the instructions direct the web browser to the uniform resource locator.

11. The system of claim 10, further comprising:
a means for adding and maintaining individual source data and correlating uniform resource locators in the first and second data sets respectively, on the database.

12. The system of claim 11, further comprising:
a means for validating individual source data and correlating uniform resource locators.

13. The system of claim 10, wherein the input data component comprises a unique identifier.

14. The system of claim 13, wherein the unique identifier comprises a telephone number.

15. The method of claim 13, wherein the unique identifier comprises one of at least a zip code, an airport code, GPS coordinates, or a jump code.

16. A method of reaching a web page identified by a uniform resource locator via a Web browser, on a user's computer connected to a global computer network, comprising:
providing a database for storing a set of unique identifiers in a first data set and a set of uniform resource locators in a second data set, correlating to at least one of the unique identifiers in the first data set, accessible via the global computer network;
providing a data entry portal for entering input data, accessible from a user's computer via the global computer network;
comparing the input data to the set of unique identifiers in the first data set to obtain the correlating uniform resource locator; and
connecting a Web browser on the user's computer with the uniform resource locator in the second data set, correlating to the unique identifier in the first data set.

17. The method of claim 16, wherein the steps of comparing the input data to the set of unique identifiers in the first data set to obtain the correlating uniform resource locator and connecting a Web browser on the user's computer with the uniform resource locator in the second data set, correlating to the unique identifier in the first data set, are initiated with a single-action submission of entered input data by the user.

18. The method of claim 16, further comprising:
providing a means for adding to the first and second data sets on the database; and
uploading at least a unique identifier and a correlating uniform resource locator.

19. The method of claim 18, further comprising:
validating the uploaded unique identifier and correlating uniform resource locator.

20. The method of claim 16, wherein the unique identifier comprises a telephone number.

21. The method of claim 16, wherein the unique identifier comprises one of at least a zip code, an airport code, GPS coordinates, or a jump code.

22. A computer readable medium comprising a computer program having executable code, the computer program for enabling data pairing, the computer program comprising instructions for:
storing a first data set having individual source data and a second data set having individual destination data correlating to individual source data in the first data set, in a database, accessible via a global computer network from a user's computer;
accepting input data entered from the user's computer;
comparing the input data to individual source data; and
sending individual destination data correlating to the individual source data to the user's computer;
wherein the individual destination data comprises a uniform resource locator.

23. The computer readable medium of claim 22, wherein the steps of equating input data to individual source data in the first data set and supplying the user's computer with the individual destination data in the second data set, correlating to the individual source data in the first data set, are initiated with a single-action submission of entered input data by the user.

24. The computer readable medium of claim 22, the computer program further comprising instructions for:
connecting a Web browser on the user's computer to the specific uniform resource locator correlating to the specific individual source data.

25. The computer readable medium of claim 22, the computer program further comprising instructions for:
providing a means for adding to the first and second data sets on the database; and
uploading individual source data and correlating individual destination data.

26. The computer readable medium of claim 22, the computer program further comprising instructions for:
validating uploaded individual source data and correlating individual destination data.

27. The computer readable medium of claim 22, wherein the input data comprises a unique identifier.

28. The computer readable medium of claim 27, wherein the unique identifier comprises a telephone number.

29. The computer readable medium of claim 27, wherein the unique identifier comprises one of at least a zip code, an airport code, GPS coordinates, or a jump code.
